(19) United States
(12) Patent Application Publication
(10) Pub. No.: US 2007/0232478 A1
(43) Pub. Date: Oct. 4, 2007

(54) ALUMINOBOROSILICATE GLASS

(76) Inventors: Joerg Fechner, Mainz (DE); Peter Brix, Mainz (DE)

Correspondence Address: HARNESS, DICKEY & PIERCE, P.L.C., P.O. BOX 828, BLOOMFIELD HILLS, MI, 48303, US

(21) Appl. No.: 11/692,358

(22) Filed: Mar. 28, 2007

(30) Foreign Application Priority Data
Mar. 31, 2006 (DE) 10 2006 016 257.9

(51) Int. Cl. C03C 3/091

(52) U.S. Cl. 501/66

(57) ABSTRACT

An aluminoborosilicate glass with a coefficient of thermal expansion CTE ≦3.3·10⁻⁶/K is disclosed, comprising the constituents (in wt. %): SiO₂ 58-70, Al₂O₃ 17-18, B₂O₃ 5-15, MgO 0-9, CaO 2-12, BaO 0.1-5, SnO₂ 0-1, As₂O₃ 0-2, the glass, apart from random impurities, being free of strontium oxide and free of alkali oxides. The proportion (in wt. %) of SiO₂.B₂O₃/Al₂O₃ is between 32 and 38, and the mean gradient of the viscosity curve is less than or equal to −5.50·10⁻³ dPas/K in the range between the common logarithm of the viscosities between 4 and 2 (i.e. for viscosities between 10⁴ dPas and 10² dPas). The glass is particularly suitable as a substrate glass, for example for LCD displays.

### RELATED APPLICATIONS

This applications claims priority of German patent application serial no. 10 2006 016 257.9, filed on Mar. 31, 2006, the contents of which are fully incorporated by reference herein.

### BACKGROUND OF THE INVENTION

The invention relates to an alkali-free aluminoborosilicate glass having properties optimised for advantageous processing, and to advantageous uses of such a glass.

LCD displays have become increasingly widespread in recent years. TFT LCD displays (active matrix thin-film transistor LCDs), especially, have a low density and low power consumption and are therefore used in many applications, for example in notebooks, in flatscreens, in digital cameras and the like. The display substrate usually consists of a glass plate in each case.

Such substrates must meet high standards. In addition to high thermal shock resistance and good resistance to the aggressive chemicals used in the production of flat screens, the glasses should also have a wide spectral range (VIS, UV), high transparency, and a low density in order to save weight. Furthermore, using them as a substrate material for integrated semiconductor circuitry, for example in TFT displays, requires that they be thermally adapted to the silicon thin-film material. When largely crystalline silicon layers are produced by high-temperature treatment at temperatures above 700° C., or by direct deposition in CVD processes, a substrate is required which has a low thermal expansion coefficient of less than 3.2·10⁻⁶/K, if possible. Another condition for applications in the field of display and photovoltaics technology is the absence of alkali ions. Production-related tolerances should preferably be less than 1000 ppm and preferably less than 100 ppm.

It is also desired that suitable glasses can be commercially produced in a cost-efficient manner and at a sufficient level of quality (no bubbles, knots or occlusions), for example in a float glass plant or in a glass drawing process (e.g. down-draw or overflow fusion). The production in drawing processes of thin (<1 mm), streakless substrates of low surface waviness, especially, requires that the glass have a high devitrification stability. In order to counteract any disadvantageous compaction of the substrate on the semiconductor microstructure during production, particularly in the case of TFT displays, the glass also needs to have a suitable temperature-dependent viscosity curve. This means that, as far as its thermal process and form stability are concerned, it should have a viscosity in the melting and processing range which is not too high, yet also have a sufficiently high transformation temperature, i.e. T_{g}≧700° C.

Due to the large-scale production of displays, an optimised viscosity curve has recently become desirable. The temperatures at viscosities above VA (10⁴ dPas) should be as low as possible. The range between VA and a viscosity of approximately 10^{1,9} dPas is particularly relevant. For example, in the range between 10⁴ dPas and 10² dPas (log 0 between 4 and 2), a steep decline in the viscosity at increasing temperature is required, i.e. the glass should be as “short” as possible in this range.

For display applications, as in LCDs and TFT LCDs, for example, suitable glasses are basically known in the prior art.

Alkali-free aluminoborosilicate glasses containing 58-65 wt. % SiO₂, 6-10.5 wt. % B₂O₃, 14-25 wt. % Al₂O₃, 0-<3 wt. % MgO, 0-9 wt. % CaO, >3-8 wt. % BaO are known from DE 100 00 836 A1, for example, in which the total content of MgO, CaO, BaO and ZnO is 0-<2.

However, the decline in viscosity over the range from 10⁴ dPas to 10² dPas is considered here to be insufficient.

A number of other aluminoborosilicate glasses for such applications and which have a high modulus of elasticity and a high specific modulus of elasticity are known from U.S. Pat. No. 6,537,937.

However, the transformation temperature of these glasses is consistently less than 700° C., which is considered disadvantageous.

Other alkali-free aluminoborosilicate glasses are known from WO 02/060831, but their viscosity curves are not optimised for processing.

### SUMMARY OF THE INVENTION

It is a first object of the invention to disclose an alkali-free aluminoborosilicate glass having an optimised viscosity curve between 10⁴ dPas and 10² dPas.

It is a second object of the invention to disclose an alkali-free aluminoborosilicate glass that is especially suitable for display applications, for example as a substrate glass for LCDs and TFT LCDs.

It is a third object of the invention to disclose an alkali-free aluminoborosilicate glass having a high transformation temperature T_{g}.

It is a forth object of the invention to disclose an alkali-free aluminoborosilicate glass that can be processed in a drawing processes to a thin (<1 mm), streakless substrates of low surface waviness.

It is a fifth object of the invention to disclose an alkali-free aluminoborosilicate glass having a high devitrification stability.

According to the invention these and other objects are accomplished by an aluminoborosilicate glass having a coefficient of thermal expansion CTE ≦3.3·10⁻⁶/K and comprising the following components (in wt. %):

| | |
|---|---|
| SiO₂ | 58-70 |
| Al₂O₃ | 17-18 |
| B₂O₃ | 5-15 |
| MgO | 0-9 |
| CaO | 2-12 |
| BaO | 0.1-5 |
| SrO | 0-4 |
| SnO₂ | 0-1 |
| As₂O₃ | 0-2, |

the glass, apart from random impurities, being free of strontium oxide and free of alkali oxides, the proportion (in wt. %) of SiO₂.B₂O₃/Al₂O₃ lying between 32 and 38, and the mean gradient of the viscosity curve being less than or equal to −5.50-10⁻³ dPas/K in the range between the common logarithm of the viscosities between 4 and 2 (i.e. for viscosities between 10⁴ dPas and 10² dPas).

The problem of the invention is completely solved in this manner.

The glasses according to the invention are characterized, namely, in that the mean gradient of the viscosity curve is less than or equal to −5.50-10⁻³ dPas/K when the common logarithm of the viscosities is between 4 and 2 (i.e. the viscosity is between 10⁴ dPas and 10² dPas). The glasses according to the invention are therefore especially short in the range of interest between 10⁴ dPas and 10² dPas.

This results in particularly good processability. It also results in a high transformation temperature of more than 700° C., preferably of more than 710° C. The coefficient of thermal expansion CTA lies within the preferred range and is ≦3.3·10⁻⁶/K. The glasses according to the invention also have a low density of less than 2500 kg/m³ and preferably less than 2450 kg/m³. The desired viscosity curve is achieved by the special ratio of SiO₂, B₂O₃ and Al₂O₃, and by the glass being free of strontium oxide.

In a preferred development of the invention, the SiO₂.B₂O₃/Al₂O₃ ratio is between 33 and 37.

The glass according to the invention can also contain 0-10 wt. %, preferably 0-5 wt. % of oxides for blocking ultraviolet light. These oxides may be Fe₂O₃, TiO₂ or CeO₂, for example.

In a preferred development of the invention, the SiO₂/Al₂O₃ ratio (expressed in wt.-%) is between 3.2 and 3.6, preferably between 3.3 and 3.55.

In another advantageous embodiment, the glass according to the invention has the following composition (in wt. %):

| | |
|---|---|
| SiO₂ | 58-70 |
| Al₂O₃ | 17-18 |
| B₂O₃ | 9.5-11 |
| MgO | 1-4 |
| CaO | 3-6 |
| BaO | >3-4 |
| SnO₂ | 0-1 |
| As₂O₃ | 0-2, |

Impurities <0.5, preferably <0.1.

The alkali oxide and strontium oxide content is preferably less than 0.1 wt. % in each case, and preferably less than 0.01 wt. %.

In one preferred development of the invention, the coefficient of thermal expansion CTA is less than 3.2·10⁻⁶/K.

This ensures that the glass can be adapted particularly well for the desired expansion characteristics.

The transformation temperature T_{g} is preferably greater than 710° C.

This results in high resistance to various processes that can occur when the glass is being processed for use in displays.

In particular, the glass according to the invention is suitable as a substrate glass, for OLEDs, AMOLEDs (active matrix OLEDs), FEDs (field emission displays), SEDs (surface emission displays), and for filters, color filters and as a color filter for TFTs.

It is also advantageous to use the glass in LCD TFT displays, in displays with backlighting of flat screen displays in non-self-emitting systems, in particular as flat glass for FFLs (flat flourescent lamps), especially for EEFL (external electrode flourescent lamp) systems with external electrodes.

The glass according to the invention can preferably be produced by the float process. It is also possible and advantageous to produce the glass using down-draw process and in particular using the overflow fusion process.

It is self-evident that the features of the invention as mentioned above and to be explained below can be applied not only in the combination specified in each case, but also in other combinations or in isolation, without departing from the scope of the invention.

Additional features and advantages derive from the following description of a preferred embodiment.

### DETAILED DESCRIPTION OF PREFERRED EMBODIMENT

### Example

The glass according to the invention preferably has the following composition (in wt. %):

| | |
|---|---|
| SiO₂ | 58-65 |
| Al₂O₃ | 17-18 |
| B₂O₃ | 9.5-11 |
| MgO | 1-4 |
| CaO | 3-6 |
| BaO | >3-4 |
| SnO₂ | 0-1 |
| As₂O₃ | 0-2, |

the SiO₂.B₂O₃/Al₂O₃ ratio (in wt. %) ranging between 32 and 38.

A mean viscosity curve gradient less than or equal to −5.50·10⁻³ dPas/K is thus achieved when the common logarithm of the viscosities is between 4 and 2 (i.e. the viscosity is between 10⁴ dPas and 10² dPas), thus resulting is particularly good processability.

Table 1 shows the composition and characteristic properties of a glass according to the invention (Example A1). The table also includes comparative examples V1 and V2, which are glasses that do not belong to the invention, whose composition deviates from the inventive glass particularly in respect of the silicon content, the aluminium oxide content and the boron oxide content, and in the respective ratios of these oxides.

The inventive glass A1 has an SiO₂.B₂O₃/Al₂O₃ ratio of 36.80 (in wt. %) and is free of strontium oxide and alkali oxides.

It also has a density less than 2.5 g·cm⁻³. The transformation temperature T_{g} is 719° C., which is well above 700° C.

The mean gradient g of the viscosity curve in the range of 10⁴ dPas and 10² dPas can be calculated from the data given in Table 1 as follows:

The mean gradient g of the viscosity curve is given by:
g=(log 0₁−log 0₂)/(T₁−T₂).

For the 0₁=10⁴ dPas and for 0₂=10² dPas the values for T₁ and T₂ are 1304° C. and 1662° C., respectively, thus:
g=(4−2)dPas/(1304° C.-1662° C.)=−5.58-10⁻³ dPas/K,
as listed in Table 1.

The mean gradient of −5.58·10⁻³ dPas/K is thus in a particularly favorable range for processing.

The coefficient of thermal expansion, at 3.15·10⁻⁶/K, is also in a preferred range.

In contrast, the behavior of the two comparative glasses V1 and V2, which are outside the range according to the invention (having a SiO₂.B₂O₃/Al₂O₃ ratio of 38.72 in the case of V1 and 40.75 in the case of V2), is much shorter in the range of interest.

TABLE 1

| Composition | Example | | |
|---|---|---|---|
| (wt.-%) | A1 | V1 | V2 |
| SiO₂ | 61.15 | 63.15 | 63.7 |
| Al₂O₃ | 17.45 | 15.9 | 16.1 |
| B₂O₃ | 10.5 | 9.75 | 10.3 |
| MgO | 2.8 | 2.8 | 0.2 |
| CaO | 4.7 | 5 | 7.8 |
| SrO | — | — | 0.8 |
| BaO | 3.2 | 3.2 | — |
| SnO₂ | 0.2 | 0.2 | — |
| As₂O₃ | — | — | 1.1 |
| α (10⁻⁶/K) | 3.15 | 3.22 | 23.21 |
| (20-300° C.) | | | |
| Tg (° C.) | 719 | 709 | 716 |
| ρ (kg/m³) | 2428.1 | 2426.7 | 2381 |
| T₄ (° C.) for | 1304 | 1308 | 1324 |
| η = 10⁴ dPas | | | |
| T₃ (° C.) for | 1458 | 1469 | 1490 |
| η = 10³ dPas | | | |
| T₂ (° C.) for | 1662 | 1687 | 1717 |
| η = 10² dPas | | | |
| T_{1.9} (° C.) for | 1692 | 1720 | 1750 |
| η = 10^{1.9} dPas | | | |
| Temp. difference | 388 | 412 | 426 |
| T_{1.9} − T₄(K) | | | |
| A (Vogel-Fulcher- | −4.063 | −3.642 | −3.422 |
| Tammann coefficient) | | | |
| B VFT coefficient | 8756.7 | 8167.7 | 7912 |
| T₀ VFT coefficient | 217.8 | 239.6 | 258.1 |
| Young's modulus (GPa) | 78 | 76 | 70 |
| Ratio SiO₂/Al₂O₃ | 3.50 | 3.97 | 3.96 |
| Ratio SiO₂ × | 36.80 | 38.72 | 40.75 |
| B₂O₃/Al₂O₃ | | | |
| Mean gradient in the | −5.58 × 10⁻³ | −5.28 × 10⁻³ | −5.28 × 10⁻³ |
| range between 10² | | | |
| dPas and 10⁴ dPas | | | |
| (dPas/K) | | | |

1. An aluminoborosilicate glass having a coefficient of thermal expansion CTE ≦3.3·10⁻⁶/K and essentially consisting of the following components (in wt. %):

| | |
|---|---|
| SiO₂ | 58-70 |
| Al₂O₃ | 17-18 |
| B₂O₃ | 9.5-11 |
| MgO | 1-4 |
| CaO | 3-6 |
| BaO | >3-4 |
| SnO₂ | 0-1 |
| As₂O₃ | 0-2, |
| Impurities | <0.5, |

said glass, apart from random impurities, being free of alkali oxides and free of strontium oxide, the proportion (in wt. %) of SiO₂.B₂O₃/Al₂O₃ lying between 33 and 37, the proportion (in wt. %) of SiO₂/Al₂O₃ lying between 3.3 and 3.55, said glass having a viscosity-temperature characteristic being defined by a mean gradient g determined by the quotient of the viscosity difference (given in the differences of the common logarithms of the viscosities in dPas) and the temperature difference (given in K), said mean gradient g≦−5.50·10⁻³ dPas/K in the viscosity range between 10⁴ dPas and 10² dPas.

2. The aluminoborosilicate glass of claim 1, comprising 0.1-10 wt. % of ultraviolet light blocking oxides.

3. The aluminoborosilicate glass of claim 1, comprising 0.5-5 wt. % of ultraviolet light blocking oxides which are selected from the group formed by Fe₂O₃, TiO₂ and CeO₂.

4. The aluminoborosilicate glass of claim 1, having the following composition (in wt. %):

| | |
|---|---|
| SiO₂ | 58-70 |
| Al₂O₃ | 17-18 |
| B₂O₃ | 9.5-11 |
| MgO | 1-4 |
| CaO | 3-6 |
| BaO | >3-4 |
| SnO₂ | 0-1 |
| As₂O₃ | 0-2, |
| Impurities | <0.5. |

5. The aluminoborosilicate glass of claim 1, wherein the alkali oxide content and strontium oxide content is less than 0.1 wt. % in each case.

6. The aluminoborosilicate glass of claim 1, wherein the alkali oxide content and strontium oxide content is less than 0.01 wt. % in each case.

7. The aluminoborosilicate glass of claim 1, wherein the thermal coefficient of expansion CTA is less than 3.2·10⁻⁶/K.

8. The aluminoborosilicate glass of claim 1, wherein the transformation temperature T_{g} is greater than 710° C.

9. The aluminoborosilicate glass of claim 1, wherein the transformation temperature T_{g} is greater than 715° C.

10. An aluminoborosilicate glass having a coefficient of thermal expansion CTE ≦3.3·10⁻⁶/K and comprising the following components (in wt. %):

| | |
|---|---|
| SiO₂ | 58-70 |
| Al₂O₃ | 17-18 |
| B₂O₃ | 5-15 |
| MgO | 0-9 |
| CaO | 2-12 |
| BaO | 0.1-5 |
| SnO₂ | 0-1 |
| As₂O₃ | 0-2, |

said glass, apart from random impurities, being free of alkali oxides and free of strontium oxide, the proportion (in wt. %) of SiO₂.B₂O₃/Al₂O₃ lying between 32 and 38, said glass having a having a viscosity-temperature characteristic being defined by a mean gradient g determined by the quotient of the viscosity difference (given in the differences of the common logarithms of the viscosities in dPas) and the temperature difference (given in K), said mean gradient g≦−5.50·10⁻³ dPas/K in the viscosity range between 10⁴ dPas and 10² dPas.

11. The aluminoborosilicate glass of claim 10, wherein the transformation temperature T_{g} is greater than 710° C.

12. The aluminoborosilicate glass of claim 10, wherein the proportion of (in wt. %) of SiO₂.B₂O₃/Al₂O₃ is between 33 and 37.

13. The aluminoborosilicate glass of claim 12, wherein the proportion of SiO₂/Al₂O₃ (in wt. %) is between 3.2 and 3.6.

14. The aluminoborosilicate glass of claim 12, wherein the proportion of SiO₂/Al₂O₃ (in wt. %) is between 3.3 and 3.55.

15. The aluminoborosilicate glass of claim 12, further comprising 0.1-10 wt. % of ultraviolet light blocking oxides.

16. The aluminoborosilicate glass of claim 12, further comprising 0.5-5 wt. % of ultraviolet light blocking oxides which are selected from the group formed by Fe₂O₃, TiO₂ and CeO₂.

17. The aluminoborosilicate glass of claim 12, wherein the thermal coefficient of expansion CTA is less than 3.2·10⁻⁶/K.

18. The aluminoborosilicate glass of claim 12, wherein the transformation temperature T_{g} is greater than 710° C.

19. The aluminoborosilicate glass of claim 12, wherein the transformation temperature T_{g} is greater than 715° C.

20. Use of the aluminoborosilicate glass of claim 10 as a substrate glass in a device selected from the group formed by a filter, an OLED, an AMOLED (active matrix OLED), an FED (field emission display), an SED (surface emission display), and a display with backlighting of a flat screen display in a non-self-emitting system.
